(19) United States
(12) Patent Application Publication
(10) Pub. No.: US 2007/0017397 A1
(43) Pub. Date: Jan. 25, 2007

(54) Image printing system, image printing method, and image printing program

(76) Inventors: Yoshihisa Kamata, Tokyo (JP); Masahiro Osawa, Tokyo (JP); Masaru Ushio, Tokyo (JP)

Correspondence Address: CANTOR COLBURN, LLP, 55 GRIFFIN ROAD SOUTH, BLOOMFIELD, CT, 06002, US

(21) Appl. No.: 11/409,787

(22) Filed: Apr. 24, 2006

(30) Foreign Application Priority Data
Jul. 20, 2005 (JP) 2005-209643

(51) Int. Cl. B41J 29/38; G03G 21/00

(52) U.S. Cl. 101/483

(57) ABSTRACT

This invention provides an image printing system including an image printing apparatus which prints an image on a sheet as a recording medium, a sheet post-processing section which performs post-processing with respect to the sheet on which an image is printed by the image printing apparatus, a storage section which stores an regulation parameter for the image printing apparatus, which is associated with setting of the sheet post-processing operation, and an regulation parameter changing section which can change the regulation parameter for each job to be executed, a control method for the system, and a control program.

### CROSS-REFERENCE TO RELATED APPLICATION

This application makes reference to, incorporates the same herein, and claims all benefits accruing under 35 U.S.C. § 119 from an application for “IMAGE PRINTING SYSTEM, IMAGE PRINTING METHOD, AND IMAGE PRINTING PROGRAM” earlier filed in Japanese Patent Office on Jul. 20, 2005, and there duly assigned No. 2005-209643.

### BACKGROUND OF THE INVENTION

1. Field of the Invention

The present invention relates to an image printing system, a control method therefor, and a control program, which can execute desired image printing operation and desired post-processing with respect to a recording medium (to be simply referred to as a sheet hereinafter).

2. Description of Related Art

A recent image printing apparatus comprises a post-processing device. Post-processing, e.g., binding a plurality of sheets into a booklet, punching, or folding predetermined sheets, with respect to sheets on which images are printed by the image printing apparatus.

In order to guarantee the quality of an image printing apparatus comprising such a post-processing device, for example, the image printing apparatus is electrically or mechanically regulated in the manufacturing process to make its printing accuracy fall within predetermined specifications so as to prevent images to be recorded on sheets from being printed upon skewing or prevent nonuniform margins. Likewise, in the post-processing device, for example, the accuracies of the positions, intervals, and the like of stapling, punching, and the like are regulated in the manufacturing process. Thereafter, the device is fixed and shipped out so as to prevent accuracy degradation.

With regard to quality after shipment, in particular, for example, a serviceman periodically visits an office or the like in which an image printing apparatus comprising a post-processing device is installed. If the accuracy or the like of the apparatus changes while it is used on the market for a long period of time, the serviceman performs regulation work to reproduce the accuracy.

For example, accuracy or the like may deteriorate depending on the state of an associated component, e.g., wear, before the serviceman visits for regulation. For this reason, there has been disclosed a technique of allowing a user to execute check copying (also called trial copying) to check copying conditions and finished states before the start of normal image printing processing in the image printing mode so as to perform desired image printing and post-processing.

When, for example, check copying is to be performed on the basis of a set copying mode, a mode which allows regulation is displayed after the execution of check copying. Alternatively, when check copying is to be executed while a mode which allows regulation associated with the quality of copy finishing is displayed on an operation display section, operability or workability associated with setting of post-processing conditions and the like is improved (see, for example, patent reference 1: Japanese Unexamined Patent Publication No. 8-95436).

According to patent reference 1, executing check copying upon changing post-processing conditions makes it possible to bring images printed on sheets to be issued or post-processing close to desired imaging printing or post-processing. However, the user cannot generally make any changes concerning regulation items like those which have been regulated and fixed at the time of manufacture, such as the positions and intervals of stapling and punching in the post-processing device, so as to maintain accuracy. For this reason, such settings cannot be changed unless the serviceman performs regulation at the time of inspection or the like.

For example, therefore, the positions, intervals, and the like of stapling, punching, and the like in the post-processing device may slightly shift depending on jobs. If such a positional shift occurs, the user has no solution other than requesting the serviceman to change regulation parameters themselves.

That is, with regulation parameters set for one kind of transfer sheet (paper) at shipment, satisfactory accuracy cannot be obtained with respect to various kinds of sheet.

Demands have therefore been growing for a technique of enhancing the function of changing regulation parameters, as in conventional regulation performed by a serviceman, and allowing the user to easily perform operation for changing regulation parameters, thereby realizing desired post-processing with satisfactory accuracy for each job to be executed.

### SUMMARY OF THE INVENTION

The present invention has been made in consideration of the above problem, and can provide an image printing system, a control method therefor, and a control program, which allow a user to easily change an regulation parameter for each job to be executed.

According to the first embodiment of the present invention, there is provided an image printing system comprising an image printing apparatus which prints an image on a sheet as a recording medium, a sheet post-processing section which performs post-processing with respect to the sheet on which an image is printed by the image printing apparatus, a storage section which stores an regulation parameter for the image printing apparatus, which is associated with setting of the sheet post-processing operation, and an regulation parameter changing section which can change the regulation parameter for each job to be executed.

According to the second aspect of the present invention, in the image printing system described in the first aspect, the regulation parameter changing section comprises a setting section, which can set a change value for the regulation parameter, and can reflect the change value in the regulation parameter to set a new regulation parameter.

According to the third aspect of the present invention, in the image printing system described in the first or second aspect, the sheet post-processing section includes a plurality of kinds of post-processing conditions to be selected, and the regulation parameter changing section can change the regulation parameter on the basis of a selected post-processing condition.

According to the fourth aspect of the present invention, in the image printing system described in the first aspect, the image printing section can set a proof copy mode for checking the sheet post-processing operation, and the regulation parameter changing section can change the regulation parameter when the proof copy mode is set.

According to the fifth aspect of the present invention, the image printing system described in the first aspect may further comprise a selection device, which can select whether to store a changed regulation parameter as a new regulation parameter in the storage section.

According to the sixth aspect of the present invention, in the image printing system described in the fifth aspect, when the selection device selects to store a changed regulation parameter as a new regulation parameter, the new regulation parameter may be stored in the storage section.

The arrangement of the present invention described in each of the above aspects can be applied not only to an image printing system but also to a control method for the system, and a control program.

The present invention can provide an image printing system, a control method therefor, and a control program which can change, for each job to be executed, an regulation parameter associated with a post-processing device which executes processing for a sheet on which an image is printed, and hence can improve workability with simple operation and can easily obtain a desired high-quality image and a sheet having undergone post-processing.

The present invention can also provide an image printing system, a control method therefor, and a control program which obtains a new regulation parameter by reflecting an input change amount in a preset regulation parameter, and hence can improve operability or workability in inputting a change value when a post-processing condition or the like is to be changed.

In addition, the present invention can also provide an image printing system, a control method therefor, and a control program which allow an regulation parameter, when a post-processing condition is selected/set, to be changed on the basis of a post-processing condition, and hence can improve operability or workability associated with setting of a selected post-processing condition, inputting of a change value for an regulation parameter, and the like.

In addition, the present invention can also provide an image printing system, a control method therefor, and a control program which can change an regulation parameter when the proof copy mode is set, and hence can improve operability or workability associated with setting of a post-processing condition and the like and can issued a sheet in a desired issuing state.

Furthermore, the present invention can also provide an image printing system, a control method therefor, and a control program which can select whether to set a changed regulation parameter as a new regulation parameter when the image printing mode is to be executed after the proof copy mode is terminated, and hence allows a check on an issuing state based on a post-processing condition or the like in the proof copy mode, can reduce unnecessary issue, and can easily obtain a desired high-quality image and a sheet having undergone post-processing.

Moreover, the present invention can also provide an image printing system, a control method therefor, and a control program in which when it is selected that a changed regulation parameter is set as a new regulation parameter, the new regulation parameter is stored in a storage section to allow the new regulation parameter stored in the storage section to be used in the subsequent execution of the image printing mode, thereby easily obtaining a desired high-quality image and a sheet having undergone post-processing.

The present invention is more specifically described in the following paragraphs by reference to the drawings attached only by way of example.

### BRIEF DESCRIPTION OF THE DRAWINGS

A more complete application of the present invention, and many other attendant features and advantages thereof, will become readily apparent as the same becomes better understood by reference to the following detailed description when considered in conjunction with the accompanying drawings in which like reference symbols and reference numerals indicate the same or similar components, wherein:

FIG. 1 is a sectional view showing the schematic arrangement of an image printing system according to an embodiment of the present invention;

FIG. 2 is a block diagram showing a circuit arrangement for image printing in the embodiment of the present invention shown in FIG. 1;

FIG. 3 is a schematic view showing an example of a “confirmation window” used for regulation in the embodiment of the present invention shown in FIG. 1;

FIG. 4 is a schematic view showing an example of an “regulation menu window” used for regulation in the embodiment of the present invention shown in FIG. 1;

FIG. 5 is a schematic view showing an example of a “finisher regulation menu window” used for regulation in the embodiment of the present invention shown in FIG. 1;

FIG. 6 is a schematic view showing an example of a “side stitcher regulation menu window” used for regulation in the embodiment of the present invention shown in FIG. 1;

FIG. 7 is a schematic view showing an example of a “stapling center position regulation window” used for regulation in the embodiment of the present invention shown in FIG. 1;

FIG. 8 is a schematic view showing an example of an “regulation parameter change confirmation window” used for regulation in the embodiment of the present invention shown in FIG. 1; and

FIG. 9 is a flowchart for explaining an example of a procedure associated with control for changing an regulation parameter.

### DETAILED DESCRIPTION OF THE PREFERRED EMBODIMENT

A preferred embodiment of the present invention will be described below with reference to the accompanying drawings. However, the present invention is not limited to this. Note that throughout the drawing, the same reference numerals denote the same parts, which will be described in detail below with reference to relevant drawings, as needed.

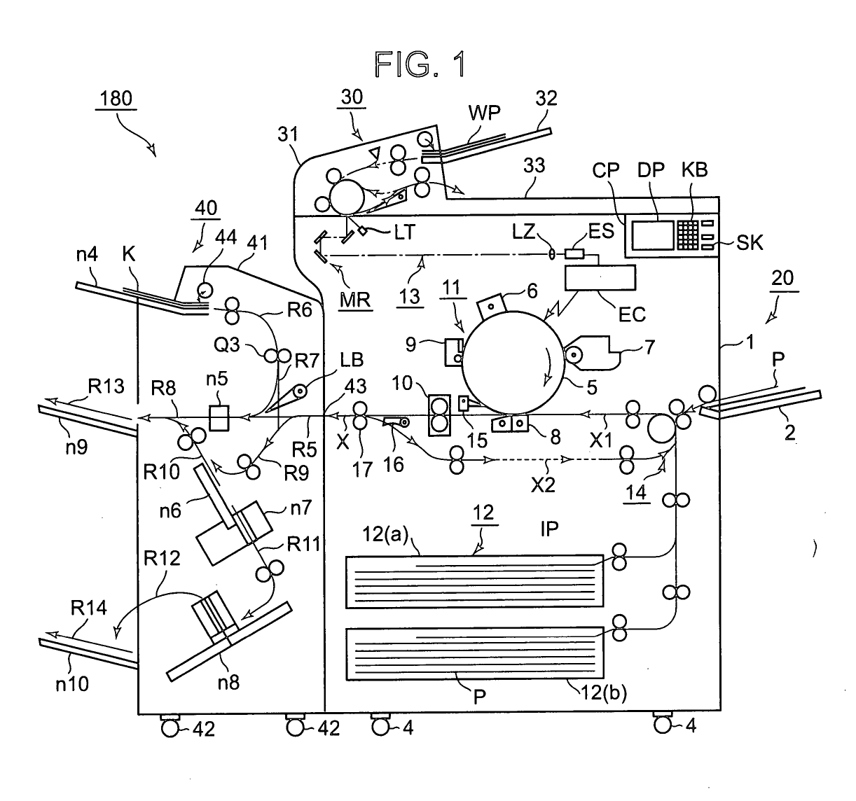

The arrangement of an image printing system according to an embodiment of the present invention will be described with reference to FIG. 1.

For the sake of descriptive convenience, assume that an image printing apparatus 20 according to an embodiment of the present invention is an electro photographic copying machine.

Reference numeral 20 denotes an image printing apparatus; 30, an automatic document feeder (ADF) mounted on the image printing apparatus 20; and 40, a post-processing device having a post-processing function of, for example, inserting (adding) a cover sheet in transfer sheets P on which images are recorded (printed), punching issued sheets, and binding and folding issued sheets.

The image printing apparatus 20 is provided with a manual feeding tray 2 at a right-side surface portion of a housing 1 to supply a relatively small number of transfer sheets P as issuing media. In addition, a left-side surface portion of the housing 1 is designed to deliver the transfer sheets P on which images are printed to convey them to the post-processing device 40. A bottom surface portion of the housing 1 is provided with a plurality of casters 4 to allow the image printing apparatus 20 to be moved.

The transfer sheets P are roughly classified into general transfer sheets P and special transfer sheets IP. The general transfer sheet P is called ordinary sheet or plain sheet. The special transfer sheets IP include thick sheet (cardboard), thin sheet, index sheet with projections called tabs, an OHP sheet, and so-called reused sheet which is a general transfer sheet P bearing an image printed on its one surface.

A control panel CP is provided on an upper portion of the front surface of the housing 1. The control panel CP incorporates a display section 300 and an operation input section 200 for setting post-processing conditions and the like to operate the image printing apparatus 20 in cooperation with the ADF 30, the post-processing device, and the like.

The control panel CP is provided with a display section DP comprising a liquid crystal display device or a touch panel type liquid crystal display device having a touch panel or the like incorporated in a display device, a keyboard KB, and an input section including a start button (also called a copy button) SK and the like.

The touch panel type display section DP is designed such that when the user touches graphic patterns such as buttons which are displayed on the display unit and on which numbers, characters, symbols, and the like are drawn, input operation including selecting information displayed on the display unit, setting information, and the like can be performed.

In the embodiment of the present invention, in particular, the touch panel type display section DP also serves as an input section for items which demand selecting/setting of post-processing conditions associated with an image printing mode of printing images on transfer sheets P or a post-processing mode of performing post-processing with respect to transfer sheets P on which images are printed.

The keyboard KB which is an input device as the operation input section 200 is mainly used to input numerical values and the like. The start button (also called the copy button) SK is used to cause the image printing apparatus 20 to start operation associated with a copy job or the like, and can start the operation of the automatic document feeder 30 or post-processing device 40 in cooperation with the image printing apparatus 20. That is, this button is used to cause the image printing system including the image printing apparatus 20, automatic document feeder 30, post-processing device 40, and the like to start executing a series of image printing operations.

The control panel CP is used to select/set, as post-processing conditions, conditions associated with the image printing mode, e.g., selecting whether printing (or copying) is performed on an issued transfer sheet in color or monochrome, whether to perform one-sided printing or duplex printing, or whether to execute post-processing. When post-processing is to be executed, detailed post-processing conditions associated with the manner of executing post-processing, e.g., binding, punching, and folding, can be selected/set by using the control panel CP.

In addition, the control panel CP allows the user to select or input various kinds of imaging printing conditions including the kind and size of transfer sheet to be used, the number of sheets to be printed or copies, enlargement/reduction, and a density setting.

According to the embodiment of the present invention, in particular, as will be described in detail later, the image printing mode can be executed, in which the post-processing device 40 is operated to execute desired post-processing after, for example, image printing operation is performed with respect to a desired number of copies on the basis of various post-processing conditions set through the control panel CP.

In order to obtain a desired issue, an issuing state of a job can be checked before the execution of the image printing mode by a proof copy mode of performing image printing operation with respect to a predetermined number of copies on the basis of various post-processing conditions set by the control panel CP.

The housing 1 incorporates a control section EC, an image printing section 11, an image reading section 13, a sheet feeding/discharging section 14, and the like.

The control section EC is also called a control circuit, which is a control section for controlling all the operations of the image printing apparatus 20 and is formed from an electric circuit comprising a CPU and the like. The control section EC is designed to drive and control all the sections constituting the image printing apparatus 20 by using the CPU on the basis of, for example, control programs and control data stored in advance.

When accessory devices such as the automatic document feeder 30 and the post-processing device 40 are connected to the image printing apparatus 20, the control section EC also functions as a control section for performing driving control to allow the overall image printing system having the image printing apparatus 20 as a main component to smoothly operate in cooperation with these accessory devices.

When the image printing apparatus 20 is connected to a personal computer, another information device, or the like through a LAN (Local Area Network), the control section EC can smoothly perform driving control including storage and exchange of information necessary for operation in cooperation with these devices.

The image printing section 11 is a section for printing images on the basis of image information on a document or the like. This section comprises, for example, a photosensitive drum (also called a photosensitive member or an image carrier) 5 which rotates in an image printing direction (e.g., the clockwise direction indicated by the arrow) set in advance by a drive source such as a motor, a charging section 6 which uniformly charges the photosensitive drum 5, an exposure section (not shown) which irradiates the photosensitive drum 5 with exposure light for forming an electrostatic latent image on the photosensitive drum 5 on the basis of image information (also called image data), a developing section 7 which visualizes the electrostatic latent image formed on the photosensitive drum 5 as a toner image, a transfer separation section 8 which transfers the toner image formed on the photosensitive drum 5 onto the transfer sheet P or the like, a cleaning section 9 for scraping off toner, sheet dust, and the like which remain on the photosensitive drum 5, a fixing section 10 for melting and fixing the transferred toner image onto the transfer sheet P, and the like.

For the sake of descriptive convenience, the embodiment of the present invention has exemplified the case wherein the image printing section 11 has one photosensitive drum 5. Obviously, however, it suffices to use, for example, a tandem type image printing section which forms images of Y (yellow), M (magenta), C (cyan), K (black), and the like on a transfer belt as an intermediate transfer member by using a plurality of photosensitive drums 5 described above, and collectively transfers them onto a transfer sheet.

Some kind of transfer sheet has a tendency to roll (also referred to as “curl”). It may become difficult to separate such a transfer sheet from the photosensitive drum depending on the state of the above curl. In order to prevent this, the embodiment of the present invention comprises a separation pawl section (separation section) 15 having a pawl member capable of contacting or retracting from the photosensitive drum 5 as a section which supports the operation of the transfer separation section 8 for separating a transfer sheet from the photosensitive drum 5.

The image reading section 13 comprises a reading optical system constituted by a light source LT, mirror group MR, imaging lens LZ, and the like and a reader ES formed from an electric circuit including a CCD (solid-state imaging device) and the like.

If the image printing apparatus 20 is a copying machine, the reader ES is located on the bottom side of the automatic document feeder 30 and is designed to read image information on a document placed on a platen glass (not shown) provided on the upper portion of the housing 1 or image information on a document fed to a reading position by the automatic document feeder 30, convert the information into digital image data, and store the image data in a storage section provided in the control section EC upon, for example, compression.

When a document fed by the ADF 30 is to be read by the image reading section 13, the light source LT irradiates the document fed to the reading position with light, reflected light from the document is formed into an image on the CCD surface of the reader ES by the imaging lens LZ through the mirror group. MR, and the image information outputted from the CCD is stored as image data in the storage section.

The sheet feeding/discharging section 14 comprises a sheet feeding cassette 12 and a sheet feeding/discharging convey section constituted by a motor as a drive source, a plurality of rollers, guide members which define convey directions, a lever which switches the convey directions, and the like.

The sheet feeding cassette 12 comprises, for example, a cassette 12a storing special transfer sheets IP and a cassette 12b storing pieces of ordinary sheet P.

The sheet feeding/discharging convey section comprises, for example, a straight convey section and a circulatory convey section. The straight convey section has a straight convey path, which allows a transfer sheet conveyed from the sheet feeding cassette 12 to be delivered upon formation of an image on one surface of the transfer sheet by the image printing section 11.

In order to print images on both the obverse and reverse surfaces of a transfer sheet, the circulatory convey section has a circulatory convey path for conveying the transfer sheet such that the convey direction is reversed during the conveyance of the transfer sheet with an image being printed on its one surface (also referred to as an obverse surface) in the delivery direction, and the obverse and reverse surfaces are also inverted to allow an image to be printed on the other surface (also referred to as a reverse surface).

The control section EC performs control as to whether either the straight convey section or the circulatory convey section is operated, upon determining print surface information (also referred to as a print mode) concerning single-sided printing or double-sided printing which is input/set by the operation input section 200.

When a transfer sheet is to be conveyed, a circulatory convey control section operates the sheet feeding/discharging convey section in accordance with an instruction from the control section EC. For example, in the single-sided mode of printing an image on one surface of a sheet, after a special transfer sheet IP or ordinary sheet P is selected and set in advance, the motor as the drive source is rotated to rotate/drive a plurality of roller groups and the like so as to feed/convey the special transfer sheet IP or ordinary sheet P selected in advance from the sheet feeding cassette 12 to the photosensitive drum 5 at a proper timing, thereby delivering/conveying the sheet upon printing of an image based on a document.

In the duplex printing mode of printing images on both surfaces of a sheet, i.e., double-sided printing (also referred to as obverse/reverse surface printing), the circulatory convey control section operates the sheet feeding/delivery convey section and the like in accordance with an instruction from the control section EC such that the rotation of reversal rollers 17 is stopped during the conveyance of the transfer sheet with an image being printing on one surface by the image printing section 11 in the discharging direction (the direction indicated by an arrow X), e.g., at the point of time when the leading end of the transfer sheet passes through the reversal rollers 17, and the rotating direction of the reversal rollers 17 is then switched to convey the transfer sheet in the direction to return it to the image printing section 11.

At the same time, a reversal member 16 is rotated clockwise to change the traveling direction of the transfer sheet conveyed in the direction of the image printing section 11 to the path (also referred to as the circulatory convey path) indicated by an arrow X2.

The transfer sheet is temporarily set in a standby state by being transferred into the circulatory convey path on the basis of the predetermined number of sheets that can be circulated. Thereafter, at a proper timing, the transfer sheet is conveyed from the direction indicated by the arrow X2 to the direction indicated by an arrow X1, and the image printing section 11 is caused to perform image printing. The double-sided printed transfer sheet is then delivered in the X direction to be conveyed to the post-processing device 40.

In general, guide members for proper conveyance of transfer sheets are often provided for the convey paths for transfer sheets. In the embodiment of the present invention, however, for the sake of descriptive convenience, an illustration and description of the guide members are omitted.

The automatic document feeder (ADF) will be briefly described below.

The ADF 30 is designed such that the overall convey device is covered by an ADF housing 31, and a document table 32 and a delivery unit 33 are provided outside the ADF housing 31.

Pluralities of documents WP are placed on the document table 32 while the surface (obverse surface) of the first-page document is located at the uppermost position. The placed document WP is conveyed to the reading position by the document convey device comprising a plurality of rollers and the like, read by the reader ES, and delivered to the delivery unit 33.

The document convey device is operated synchronously with the control section EC of the image printing apparatus 20 by a driving control circuit (not shown).

The arrangement of the post-processing device 40 will be briefly described below.

The overall post-processing device 40 is covered by a post-processing device housing 41. A right-side surface portion of the housing 41 (on the image printing apparatus 20 side) is provided with an insertion port 43 for receiving an image-printed transfer sheet delivered from the image printing apparatus 20. A left-side surface portion of the housing 41 is provided with a cover sheet feeding portion n4 on which a cover sheet K is placed before being fed, a delivery tray (stack portion) n9 on which, for example, a bound transfer sheet bundle is stacked, and a delivery tray n10 which receives a folded transfer sheet bundle. A bottom portion of the housing 41 is provided with a plurality of rollers 42 for allowing the post-processing device 40 to be moved.

The housing 41 incorporates a driving control circuit and a drive source such as a motor (which are not shown) so as to operate synchronously with the control section EC of the image printing apparatus 20. In addition, the housing 41 is provided with a shifting unit/punching unit (also referred to as a punching device) n5, intermediate stacker (stack portion) n6, stapler (binding device) n7, and folding device n8, and also comprises convey paths R5, R6, R7, R8, R9, R10, R11, R12, R13, and R14.

The convey paths R5 to R11 are formed by a post-processing convey device in which a plurality of convey roller pairs comprising driving rollers and driven rollers are arranged. For example, there are provided, along the convey path R6, a pickup roller 44 which picks up cover sheets K one by one and a pre-feeding stop position Q3 formed by a convey roller pair which can temporarily stop the conveyance of the picked cover sheet K and set it in a standby state.

In addition, there is provided a convey path changing section comprising a guide LB which can rotate to change the convey path RS to the convey path R8 or R9 or change the convey path R7 to the convey path R8 or R9.

Note that as a cover sheet K used as a book cover or the like, a sheet made of a material such as a sheet or a resin film is generally used. In some cases, a sheet made of a special material or having underdone special processing, e.g., a sheet made of wood, leather, or metal foil, may be used.

The operation of the post-processing device 40 will be described next.

For the sake of descriptive convenience, assume that a cover sheet is inserted as a book cover, and it is known in advance that the cover sheet K is inserted as a book cover. Assume that these preconditions are set in advance by the operation input section 200 of the image printing apparatus 20.

When a cover sheet K is to be inserted, the post-processing convey device is operated through the driving control circuit of the post-processing device 40 which operates in cooperation with the image printing apparatus 20 to make the pickup roller 44 pick up the cover sheets K placed on the cover sheet feeding portion n4 one by one, convey the sheet along the convey path R6, and stop it at a position where its leading end is in contact with the pre-feeding stop position Q3.

The post-processing convey device is activated again in accordance with information from the image printing apparatus 20 at the timing when an image-printed transfer sheet is delivered from the image printing apparatus 20, and the cover sheet K which is stopped at the pre-feeding stop position Q3 and is set in the standby state is fed out (conveyed again) and travels along the convey path R7.

When stapling (binding), punching, or folding is not to be performed, since the guide LB is stopped at the position in FIG. 1, the sheet is conveyed from the convey path R7 to the convey path R8 and to the convey path R13, and is delivered to the delivery tray n9. Subsequently, the image-printed transfer sheet enters the convey path R5 through the insertion port 43, is conveyed from R8 to R13, and delivered to the delivery tray n9, thereby forming a transfer sheet bundle with a cover sheet.

When stapling, punching, or folding is to be performed, since the guide LB is rotated counterclockwise from the position in FIG. 1 and stopped, the cover sheet K is fed out from the pre-feeding stop position Q3. This sheet is further conveyed from the convey path R7 and delivered to the intermediate stacker n6 along the convey path R9.

Likewise, when an image-printed transfer sheet enters the convey path R5 through the insertion port 43, since the guide LB is rotated counterclockwise at the position in FIG. 1 and stopped, the transfer sheet cannot be conveyed to the convey path R8 and its direction is changed to the convey path R9. The sheet is then conveyed along the convey path R9 and delivered to the intermediate stacker n6. At this time, on the intermediate stacker n6, the cover sheet K delivered first and the succeeding transfer sheets are registered, thereby forming a transfer sheet bundle with the cover sheet.

When stapling is to be performed, the cover sheet K and transfer sheets are bound together by the stapler n7, and the bundle is conveyed from the convey path R10 to the convey path R13 and delivered to the delivery tray n9, thereby forming a bound transfer sheet bundle with the cover sheet.

When stapling or punching and folding are to be performed, for example, the cover sheet K and transfer sheets are punched by the punching device n5 and bound by the stapler n7. Thereafter, the transfer sheet bundle is conveyed along the convey path R11, and the cover sheet K and the transfer sheets are folded together by the folding device n8. The transfer sheet bundle is then conveyed from the convey path R12 to the convey path R14 and delivered to the delivery tray n10, thereby forming a bound or folded transfer sheet bundle with the cover sheet.

When sorting is to be performed, the cover sheet K is temporarily stopped at the shifting unit n5 provided midway along the convey path R8. At this position, succeeding transfer sheets are stacked. Thereafter, the cover sheet K and the transfer sheets can be moved together in the up/down direction which is perpendicular to the convey direction and parallel to a sheet surface. Although not shown, the delivery tray n9 is configured to have a plurality of stages, and hence cover sheets K can be conveyed to the respective stages of the delivery tray n9 by cooperative operation between the shifting unit n5 and the delivery tray n9.

When folding is to be simply performed, the cover sheet K and transfer sheets delivered and stacked on the intermediate stacker n6 are registered on the intermediate stacker n6, and are conveyed to the folding device n8 along the convey path R11. After these sheets are then folded by the folding device n8, they are conveyed from the convey path R12 to the convey path R3 and are delivered to the delivery tray n10. Note that these sheets may be delivered from the folding device n8 to the delivery tray n9.

Although a description of the detailed arrangements of the punching deice n5 and binding device n7 will be omitted in the embodiment of the present invention, the positions and intervals of stapling and punching by the punching device n5 and binding device n7 provided for the post-processing device 40 can be changed with respect to transfer sheets by operating actuators forming the punching device n5 and binding device n7 with predetermined operation.

In the manufacturing process for the image printing apparatus, in particular, the above actuators are operated with predetermined operation on the basis of a preset regulation program to as to make reference positions, intervals, and the like of stapling, punching, and the like fall within predetermined specifications. Regulation values set by regulating operation and regulation value set by manual regulating operation are then stored as regulation parameters in the storage section. Thereafter, the resultant image printing apparatus is then shipped out as a product.

In the embodiment of the present invention, although not described in detail, in order to allow a user to generate his/her own printed matter such as a booklet by operating the control panel CP using this regulation program, the reference positions, intervals, and the like of stapling, punching, and the like can be arbitrarily set.

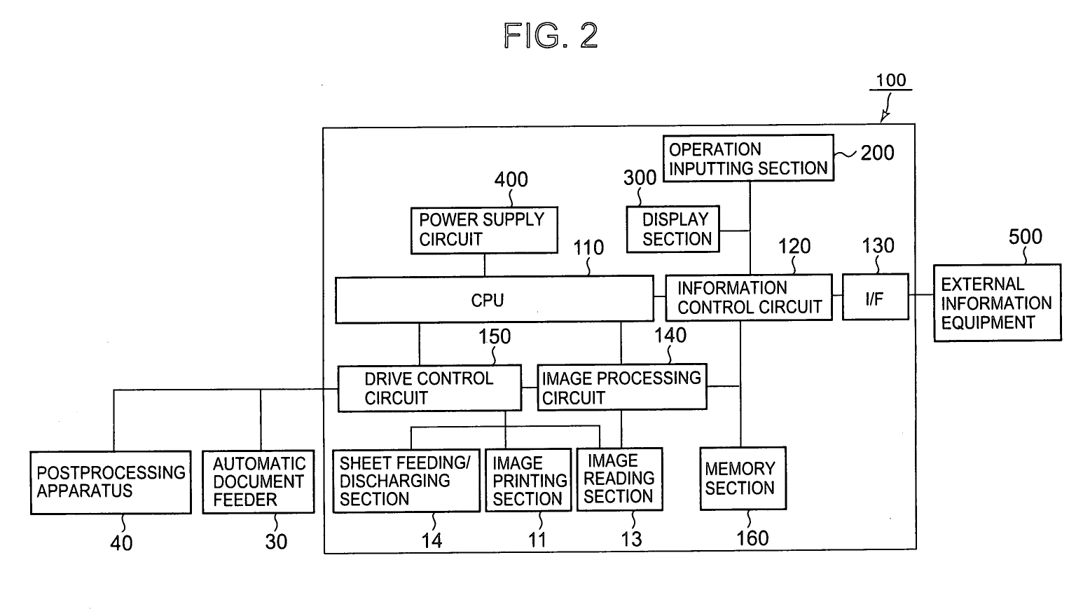

The circuit arrangement of an image printing system 180 according to the embodiment of the present invention will be described next with reference to FIG. 2.

Reference numeral 100 denotes an arrangement between various kinds of sections and circuits of the image printing apparatus 20; and 110, a CPU which controls the overall image printing apparatus and in which programs for various kinds of modes for controlling the image printing apparatus 20, data required for the execution of the programs, and the like are stored in advance.

An information control circuit 120, image processing circuit 140, driving control circuit 150, power supply circuit 400, and the like are connected to the CPU 110. The control section EC shown in FIG. 1 comprises these circuits and the CPU 110, and can control the overall image printing system comprising the image printing apparatus 20 as a main component in cooperation with the automatic document feeder 30 and post-processing device 40 (to be described later).

The information control circuit 120 is connected to an external information device 500 through an interface (I/F) 130 to receive image information such as character or image information and setting information such as a density and magnification required for image printing or the like as job information for each job as one print unit and store it in a storage section 160 in accordance with an instruction from the CPU 110. In addition, setting information and the like stored in the storage section 160 are outputted to the image processing circuit 140, driving control circuit 150, display section 300, or the like.

Although described in detail later, the information control circuit 120 includes a function of inputting/outputting, in addition to job information inputted from the external information device 500, data (also referred to as job data) accompanying job information, e.g., instruction information associated with detailed control for the operation of various kinds of circuits and sections including the image processing circuit 140 and the driving control circuit 150, and automatically and smoothly transferring various kinds of information and the like associated with the type of transfer sheet, the image printing mode, and the like input through the operation input section 200 to various circuits and sections of the image printing apparatus without interfering with the operation of the image printing apparatus, as needed.

The information control circuit 120 also has a function of determining various kinds of information outputted from sensors and the like provided for various kinds of circuits and sections and supporting the CPU 110 to issue proper instructions.

The external information device 500 is mainly a computer or Internet server, but in some cases is assumed to be another image printing apparatus on a local area network (LAN) or an information apparatus such as a measurement apparatus, which can output information measured by a digital camera.

Note that the information control circuit 120 determines whether the post-processing mode of performing post-processing has been selected by the operation input section 200. If the post-processing mode has been selected, the information control circuit 120 inputs information indicating that the post-processing mode has been set to the CPU 110. The CPU 110 executes a preset program to operate the post-processing device through the driving control circuit 150 so as to perform operation corresponding to the selected post-processing.

Assume that when the post-processing mode is executed, the positions or intervals of stapling or punching, the number of portions to be stapled or punched, or the like is changed with respect to the punching device n5 or binding device n7 provided for the post-processing device 40. In this case, when a change value for changing the positions or intervals, the number of portions to be stapled or punched, or the like is input through the operation input section 200, the information control circuit 120 can change the corresponding regulation parameter stored in advance in the storage section in accordance with the change value.

If the proof copy mode has been selected before the execution of the image printing mode, the information control circuit 120 functions to operate the image processing circuit 140 or the driving control circuit 150 to issue a transfer sheet under preset post-processing conditions, thereby allowing the user to check the issuing state of the transfer sheet.

In addition, when the proof copy mode is executed, the post-processing conditions and the like set in the proof copy mode are displayed on the display section 300 such as a liquid crystal display device. If a satisfactory transfer sheet issued result cannot be obtained, the user can repeatedly change the post-processing conditions, instead of storing the set conditions as new regulation parameters in the storage section, until a satisfactory transfer sheet issued result can be obtained by referring to the post-processing conditions and the like displayed on the display section 300.

When a desired transfer sheet issued result can be obtained under the set post-processing conditions, the conditions can be stored as regulation parameters in the storage section. If the user performs selecting/setting operation through, for example, the control panel CP to store the new regulation parameters in the storage section, the image printing mode will be executed afterward by using the regulation parameters stored as the new regulation parameters in the storage section.

For the sake of descriptive convenience, the conditions set in the proof copy mode are regarded as post-processing conditions obviously, however, the conditions that can be set in the proof copy mode are not limited to post-processing conditions.

The interface (I/F) 130 is an information exchange section, which is configured to be connected to the external information device 500 such as the above computer, another image printing apparatus, or an Internet server through various kinds of networks.

The operation input section 200 comprises the keyboard KB provided for the control panel CP of the image printing apparatus 20, the input device comprising the start button SK and the like, the touch panel type liquid crystal display device DP also serving as a display device and the like.

If, for example, the start button SK is pressed, the apparatus starts conveying a document placed on the ADF 30 and starts copying operation. If the post-processing mode is set, the apparatus executes the image printing mode in cooperation with the post-processing device 40.

The user can input setting information such as the number of transfer sheets to be issued, the type of transfer sheet (e.g., index sheet, cardboard, ordinary sheet, thin sheet, recycled sheet, an OHP sheet, reused sheet, or the like), a magnification such as an enlargement/reduction ratio or the like, the density of an outputted image, and the like by operating the keyboard KB, and can set various operation modes of the image printing apparatus 20 by using the liquid crystal display device DP.

The image printing mode includes, for example, four modes, i.e., (1) performing single-sided printing-out operation for a single-sided printed document, (2) performing double-sided printing-out operation for a single-sided printed document, (3) performing single-sided printing-out operation for a double-sided printed document, and (4) performing double-sided printing-out operation for a double-sided printed document. These modes are displayed as buttons on the liquid crystal display device DP, and the user can select/set one of them.

In the embodiment of the present invention, the user can set post-processing conditions for the post-processing device 40, in particular, by using the touch panel type liquid crystal display device DP which can perform both display operation and input operation. For example, the user can set a post-processing mode such as cover sheet insertion, stapling, punching, folding, or sorting, can set, in the cover sheet insertion mode, the number of pages as positions at which cover sheets are to be inserted, or can set various kinds of conditions as cover sheet insertion conditions, e.g., the type of cover sheet such as an obverse cover sheet, a reverse cover sheet, an obverse/reverse cover sheet which serves as both obverse and reverse cover sheets when being folded, or a cover sheet for intermediate insertion.

In the embodiment of the present invention, when a predetermined number of pages are to be folded into a booklet by post-processing, in particular, the user can change the positions or intervals of stapling or punching with respect to transfer sheets or the number of portions to be stapled or punched by performing predetermined operation through the control panel CP. In addition, for example, the user can perform setting so as to perform stapling, punching, and the like while avoiding important images printed on transfer sheets.

The image processing circuit 140 is a circuit, which converts image information on a document read by the image reading section 13 into, for example, digital data, and stores it as image data in the storage section 160 upon compression. In addition, when the image printing section 11 is to print an image, this circuit decompresses image data stored in the storage section 160 and coverts it into data, a signal, or the like suitable for the image printing scheme employed by the image printing section 11.

The driving control circuit 150 is a circuit for causing the image printing section 11, image reading section 13, sheet feeding section 14, ADF 30, post-processing device 40, and the like to operate at proper timings on the basis of a preset operation mode, thereby performing image printing operation.

The storage section 160 stores image data necessary for image printing, job information and job data comprising set conditions and the like for controlling the image printing apparatus 20, and information such as programs for various set modes to be executed by the image printing apparatus 20.

Note that in the embodiment of the present invention, job information and job data are defined as follows.

If the image printing apparatus 20 is a copying machine, job information means information about each job, e.g., setting a document, selecting the single-sided or double-sided mode, selecting a sheet feeding cassette, selecting the number of copies, and selecting a print density on the basis of image information on the document, and is a series of image data determined by making setting of issue and issuing a copy start instruction. Such a print data set corresponding to one print instruction (also referred to as one print unit) is referred to as one job.

Likewise, if the image printing apparatus is a printer, a series of print data transmitted from the external information device 500 is referred to as job information, and a print data set corresponding to one print instruction is referred to as one job. Handling job information or job data on a job basis is referred to as one job unit.

Note that job data is data accompanying job information, e.g., a convey velocity setting corresponding to a transfer sheet, or the data of control values associated with detailed control items for the execution of image printing operation.

Job information and job data are therefore stored in the storage section 160 on a job basis, i.e., for each single job unit (also simply referred to as a job unit).

In the embodiment of the present invention, regulation parameters, change values for changing the regulation parameters, or the like for the post-processing device or image printing apparatus in the image printing system, in particular, can be stored in the storage section 160.

As shown in FIG. 1, the image printing section 11 comprises the photosensitive drum 5, charging section 6, developing section 7, transfer separation section 8, cleaning section 9, fixing section 10, separation pawl section 15, and the like, and is operated by the driving control circuit 150.

The image printing section 11 is therefore controlled on the basis of the image data, job information, and job data read by the image reading section 13 and stored in the storage section 160 to print an image on the photosensitive drum 5 and transfer/record the image onto the ordinary sheet P or reused sheet IP.

As shown in FIG. 1, the image reading section 13 comprises the reading optical system and the reader ES, and is operated by the driving control circuit 150 to read image information on a document conveyed to the reading position through the reader ES. The read image information is, for example, converted into digital image data and compressed by the image processing circuit 140. The resultant data is then stored in the storage section 160.

The sheet feeding section 14 comprises the sheet feeding cassette 12., the sheet feeding/discharging convey section, the circulatory convey control section, and a section, which sets the number of sheets that can be circulated.

As shown in FIG. 1, the automatic document feeder (ADF) 30 is a device which causes the document convey device to automatically convey documents placed on the document table 32 one by one, and operates in cooperated with the driving control circuit 150 in accordance with an instruction from the CPU 110 of the image printing apparatus 20.

The post-processing device 40 operates the post-processing convey device in cooperation with the driving control circuit 150 through the driving control circuit of the post-processing device 40 in accordance with an instruction from the CPU 110, and executes a post-processing mode for cover sheet insertion, stapling, folding, or sorting on the basis of a preset program and post-processing conditions and the like set through the operation input section 200.

When the power switch (not shown) of the power supply circuit 400 is turned on by the user, proper power is supplied from the power supply to the overall image printing apparatus. When the power switch is turned off, the supply of power is interrupted.

In the case of a power saving mode of setting, for example, the image printing apparatus in the standby state, even when the power switch is turned on, only the supply of power necessary for temporary storage of the contents of the memory and the like is continued, but the supply of power to other components, e.g., the heater of the fixing section, is interrupted.

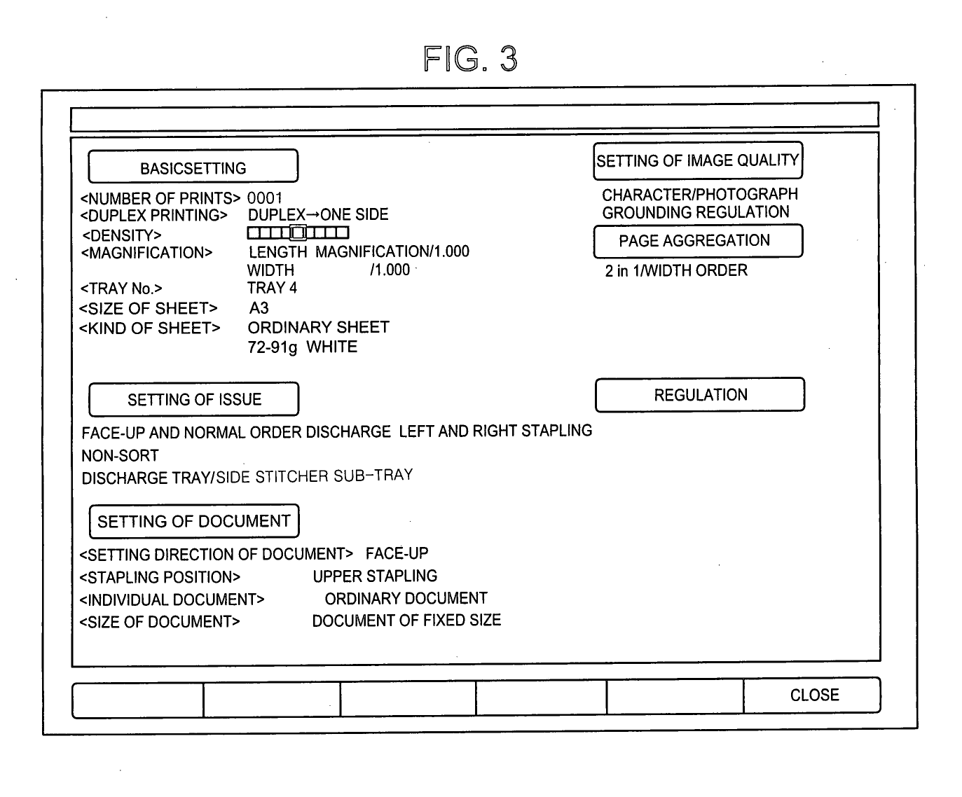

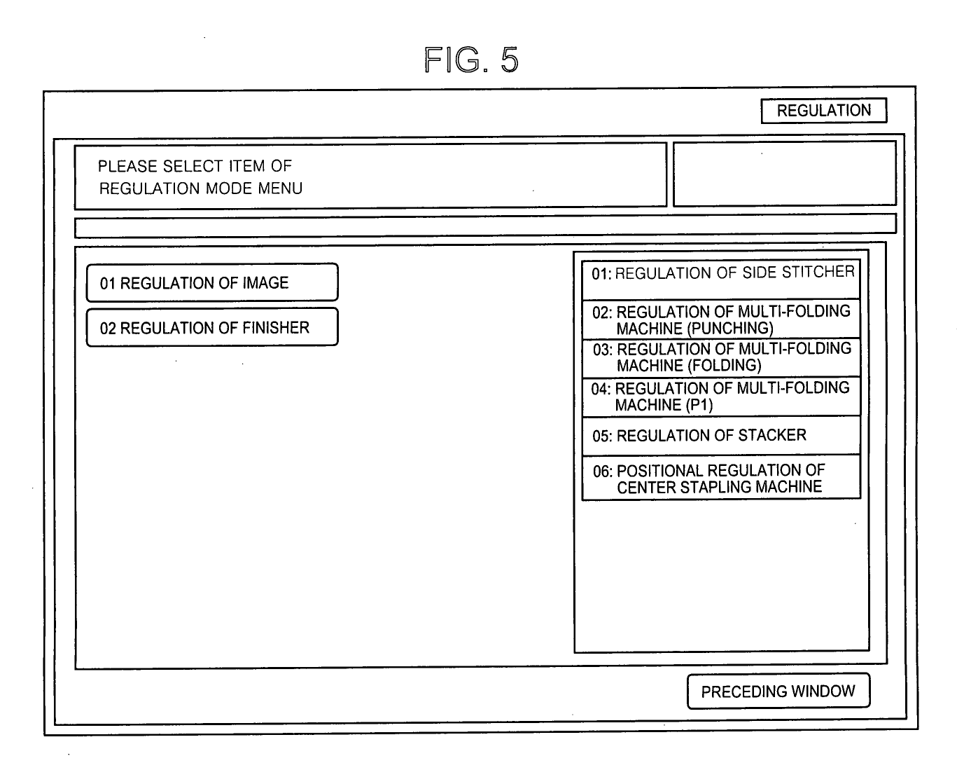

An operation sequence for changing regulation parameters in the post-processing device according to the embodiment of the present invention will be described next with reference to FIGS. 3 to 8.

In general, the post-processing device and the image printing apparatus comprise a plurality of units. Each unit or the like is regulated in advance to fall within the range of predetermined specifications in the manufacturing process or the like before shipment. Such regulation values are called regulation parameters and are stored in the storage section 160 of the control section EC, as described above.

In general, the post-processing device or image printing apparatus in the image printing system executes image printing operation such as predetermined post-processing and image printing on the basis of regulation parameters set in advance in the manufacturing process or the like.

In some cases, even if the post-processing device or the image printing apparatus operates on the basis of regulation parameters, an image printed on a sheet or post-processing state as an issued result falls outside specifications because components and the like wear out over the time of use.

According to the embodiment of the present invention, temporary regulation parameters are obtained by changing regulation parameters in accordance with change values, and proof copying is performed by using the temporary regulation parameters. If a desired result is obtained, the temporary regulation parameters are set as new regulation parameters, and image printing operation is performed on the basis of the new regulation parameters, thereby making correction such that images outputted onto sheets or post-processing for the sheets fall within the specifications. Alternatively, the user can obtain a desired issue by intentionally reflecting change values in regulation parameters by using this regulating function.

The regulation of the post-processing device (also referred to as a finisher) according to the embodiment of the present invention will be described first. Although the details of regulation will be omitted, regulations are classified into, for example, (01) side stitcher regulation, (02) multi-folder (punching) regulation, (03) multi-folder (folding) regulation, (04) multi-folder (PI) regulation, (05) stacker regulation, (06) saddle stitching lateral position regulation, and (07) regulation for standard data restoration. In addition, the following regulations are provided for the respective classifications. (01) Side stitcher regulation is provided with (01-01) stapling center position regulation: regulating a stapling center position at the time of stapling, and (01-02) sheet width regulation: making regulation when there is a deviation in a sheet bundle at the time of stapling. (02) Multi-folder (punching) regulation is provided with (02-01) sheet width regulation: regulating the width of a registration plate in accordance with the corresponding size of sheet when a punched hole position deviation is large, and (02-02) punched hole vertical position regulation: regulating the punched hole position in the sub-scanning direction. (03) Multi-folder (folding) regulation is provided with (03-01) center folding position regulation: regulating a folding position at the time of center folding/printing operation, (03-02) C-folding position regulation: regulating a folding position at the time of C-folding printing operation, (03-03) outside three-folding position regulation: regulating a folding position at the time of outside three-folding printing operation, (03-04) double parallel folding position regulation: regulating a folding position at the time of double parallel folding printing operation, (03-05) Z-folding position regulation: regulating a folding position at the time of Z-folding, (03-06) 8-page parallel fold position regulation: regulating a folding position at the time of 8-page parallel fold, and (03-07) folding registration loop amount regulation: regulating fold bend, sheet crease, or jam at the registration portion by regulating the sheet loop amount of the registration roller portion. (04) Multi-folder (PI) regulation is provided with (04-01) tray size regulation: multi-folder (PI) regulation, which is not used on the market. (05) Stacker regulation is provided with (05-01) sheet width regulation: making regulation when there is a sheet discharging deviation in the main scanning direction of the stacker tray; this regulation is performed by regulating the position of the registration plate at the time of registration, and (05-02) length regulation: making regulation when there is a sheet discharging deviation in the sub-scanning direction of the stacker tray; this regulation is made by regulating the position of the end stopper. (06) Saddle stitching lateral position regulation is performed when there is a positional shift in the lateral direction at the time of saddle stitching. (07) Regulation for standard data restoration is performed to restore various set values for finisher regulation at the time of shipment or installation.

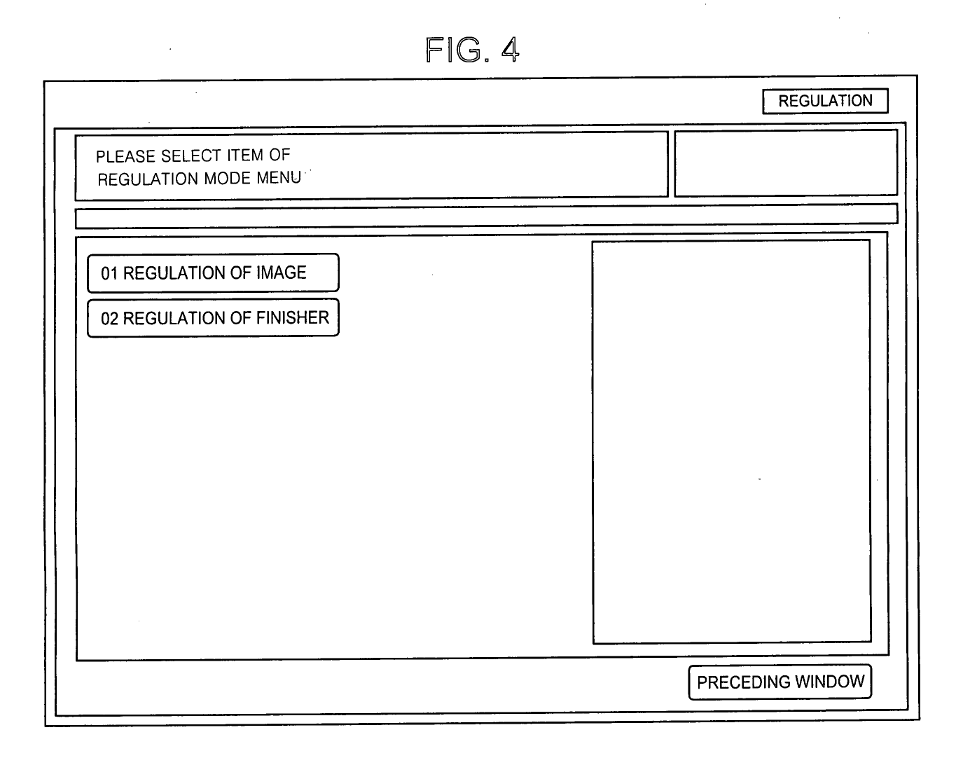

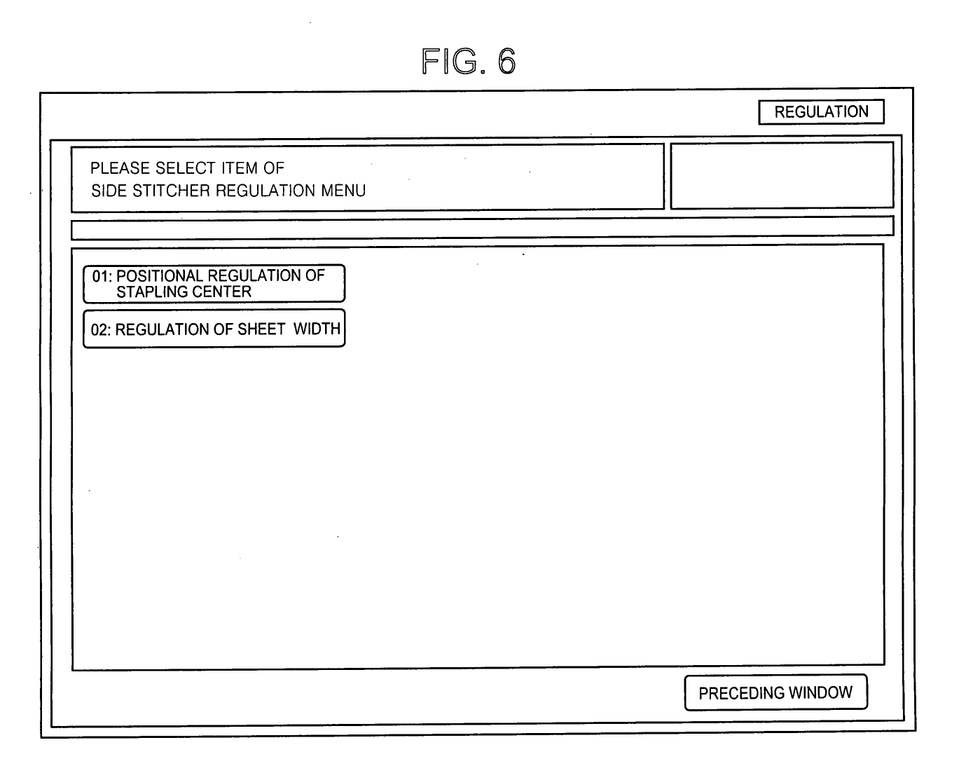

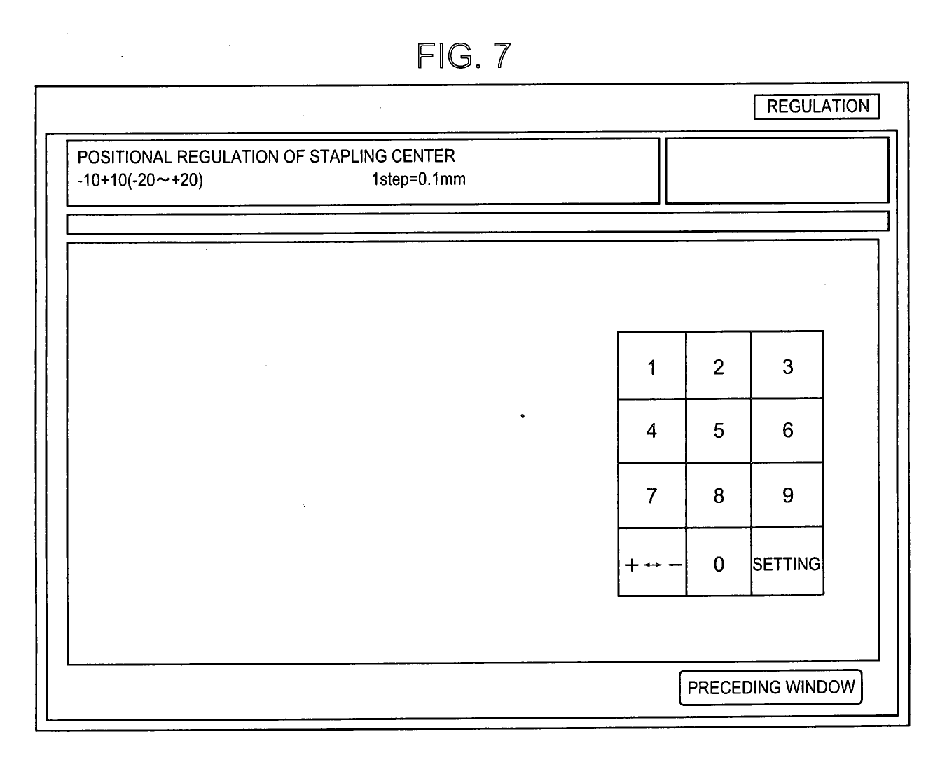

(01-01) Stapling center position regulation in (01) side stitcher regulation will be described as an example. Assume that a deviation amount a of the stapling center position of the side stitcher falls outside a specification, and the position is to be corrected within the specification. (1) First of all, the control panel CP is operated to select the proof copy mode from various operation modes. When the proof copy mode is selected, since the “confirmation window” shown in FIG. 3 is displayed, basic setting, setting of issue, and the like associated with image printing are performed through the “confirmation window” in FIG. 3: If, for example, the sheet to be used is A3 ordinary sheet, A3 is selected as <size of sheet>, and ordinary sheet is selected as <kind of sheet>. In order to check the deviation amount a, although not shown, “test pattern (No16)” which is a preset test pattern to be used for side stitcher regulation is selected from test pattern selection items, and the start button SK is pressed. (2) When the start button SK is pressed, a test pattern is printed on the A3 sheet and issue. The issued A3 sheet is folded at the center in the convey direction, and the deviation amount a is checked from the difference between the stapling center mark of the test pattern and the fold of the A3 sheet. Assume that a specification as the deviation amount a is set to ±3 mm. (3) When the deviation amount a is to be regulated, the proof copy mode on the control panel CP is selected again. Since the “confirmation window” in FIG. 3 is displayed, the “regulation” key in the “confirmation window” in FIG. 3 is pressed. (4) When the “regulation” key is pressed, the “regulation menu window” in FIG. 4 is displayed. The “02 finisher regulation” key in FIG. 4 is pressed. (5) When the “02 finisher regulation” key is pressed, the “submenu” comprising regulation items 01 to 06 is displayed on the right side of the “finisher regulation menu window”. The “01 side stitcher regulation” key is selected from the “submenu” and is pressed. (6) When the “01 side stitcher regulation” key is pressed, since the “side stitcher regulation menu window” in FIG. 6 is displayed, the “01 stapling center position regulation” key is pressed. (7) When the “01 stapling center position regulation” key is pressed, the “stapling center position regulation window” in FIG. 7 is displayed. (8) If, for example, the deviation amount a falls outside the specification, i.e., ±3 mm, a change value for correcting the deviation amount a between the stapling center mark of the above test pattern and the fold so as to make the deviation amount fall within the specification, i.e., ±3 mm, is input by using the “ten-key pad” in the “stapling center position regulation window” in FIG. 7.

Assume that the deviation amount a is to be regulated within the range of ±1 mm. In this case, since 1 step=0.1 mm as shown in FIG. 7, if −10 (Step) and +10 (Step) are input as regulation values, “−10+10 (−20+20)” and “1 step=0.1 mm” are displayed in “stapling center position regulation window” in FIG. 7. Note that (−20+20) indicates a settable range.

In order to make the deviation value a fall within the specification, procedures (1) to (8) described above may be executed.

As will be described in detail later, the change values input in procedures (1) to (8) are received instead of regulation parameters stored in advance in the storage section, and the received values are stored as “temporary regulation parameters” in the storage section 160 to be used when issuing operation is performed in the proof copy mode.

That is, executing the proof copy mode with the “temporary regulation parameters” makes it possible to check whether the deviation amount a falls within the specification. If the deviation amount a falls outside the specification, the amount can be made to fall within the specification by changing regulation values.

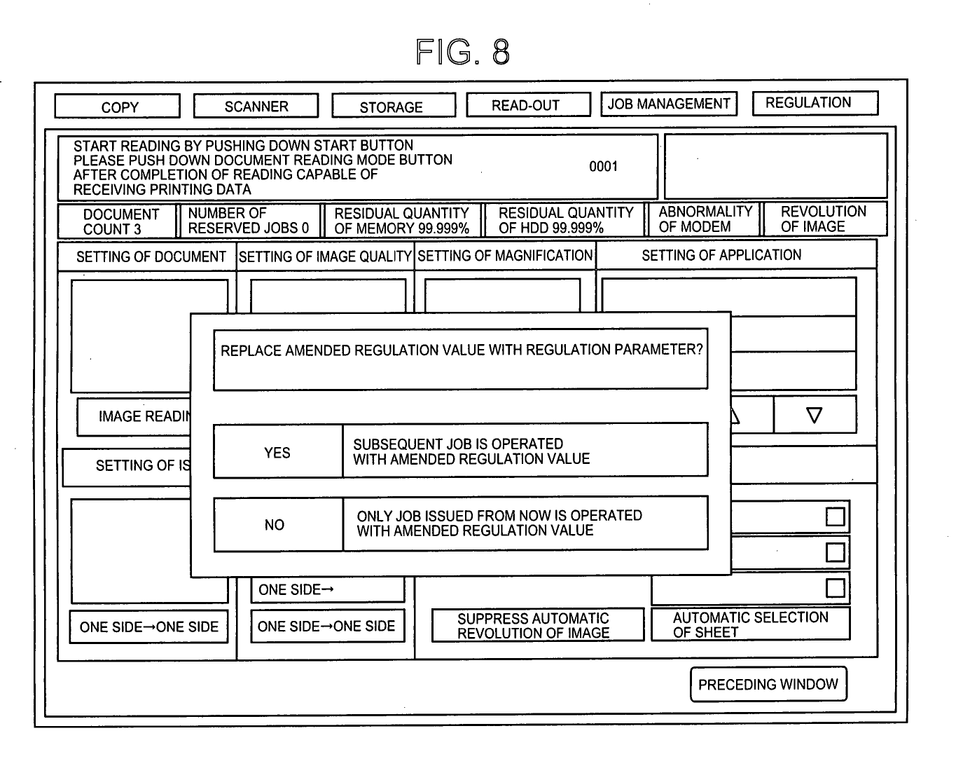

In the embodiment of the present invention, when the proof copy mode is terminated, a proof copy window (regulation parameter change confirmation window) of the “stapling center position change confirmation window (side stitcher regulation)” in FIG. 8 is displayed to allow the user to check displayed currently set conditions and the like.

A popup window is displayed in the proof copy window of the “stapling center position change confirmation window (side stitcher regulation)” in FIG. 8 to allow the user to select between replacing regulation parameters stored in advance in the storage section 160 with the “temporary regulation parameters” described above as “new regulation parameters” when the subsequent image printing mode is executed and making the “temporary regulation parameters” effective only in the current proof copy mode and to set the parameters.

Assume that when the subsequent image printing mode is to be executed, the user selects to change regulation parameters (YES). In this case, the “temporary regulation parameters” are stored as “new regulation parameters” in the storage section 160 instead of regulation parameters stored in advance in the storage section 160. When the subsequent image printing mode is executed, the “new regulation parameters” are always used.

If the user selects to make the “temporary regulation parameters” effective only in the proof copy mode (NO), the “temporary regulation parameters” stored in the storage section 160 are erased.

In the embodiment of the present invention, as described above, for example, in order to correct the deviation amount a within the specification, input regulation values are added to regulation parameters, and regulation values set in consideration of, for example, the relationship with an image to be printed on a sheet so as to arbitrarily change the stapling center position. In this case as well, parameters can be changed by the same procedures as those described above.

In the embodiment of the present invention, “temporary regulation parameters” are stored in the storage section 160. However, it suffices to calculate “temporary regulation parameters” in each case as needed or display them only in a window instead of storing them in the storage section 160.

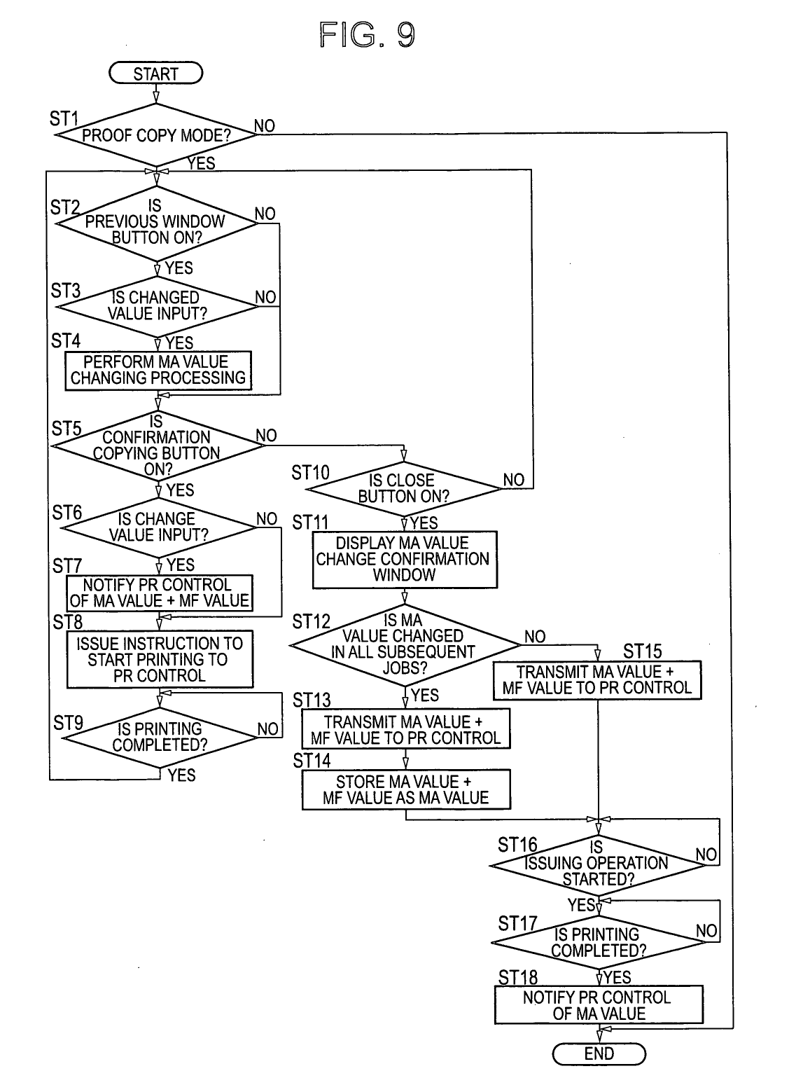

A control procedure for changing regulation parameters in the post-processing device in the proof copy mode will be described next with reference to the flowchart of FIG. 9. (ST1) is a step of determining whether the proof copy mode is selected. If the proof copy mode is selected, the flow advances to step ST2. If this mode is not selected, regulation parameter change control is not executed, and the processing is terminated.

(ST2) is a step of determining whether a previous window button is pressed. If the “previous window” button in the “regulation menu window” shown in FIG. 4 is pressed, the flow advances to step ST3. If this button is not pressed, the flow advances to step ST5.

That is, since an regulation parameter (MA value) is changed in accordance with the windows shown in FIGS. 3 to 7, when the “previous window” in the “regulation menu window” shown in FIG. 4 is pressed, some operation is performed to change the MA value. As a consequence, the previous state of the “regulation menu window” shown in FIG. 4 is restored. That is, the regulation mode returns from the regulation mode to the normal mode.

(ST3) is a step of determining whether a change value (MF value) is inputting. If a change value (MF value) for changing the MA value is input, the flow advances to step ST3. If no MF value is input, the flow advances to step ST4.

(ST4) is a step of performing processing of changing a regulation parameter (MA value). If a change value is input, the change value (MF value) is reflected in the regulation parameter (MA value) to obtain a “temporary regulation parameter”. The flow then advances to step ST5.

Although not described in detail, the MA value can be regulated by procedures (1) to (8) as in the case of regulation for the deviation value a of the stapling center position in the above side stitcher.

(ST5) is a step of determining whether a proof copy button (also referred to as a confirmation copy button) is turned on. If the proof copy button is ON, the flow advances to step ST6 to execute proof copying in the proof copy mode.

(ST6) is a step of determining whether a change value (MF value) is inputting. If an MF value is input, the flow advances to step ST7. If no MF value is input, the flow advances to step ST8.

(ST7) is a step of notifying the printer control unit (PR control) of a “temporary regulation parameter” obtained by reflecting the MF value (change value) in the MA value (regulation parameter). When a “temporary regulation parameter” is obtained by reflecting the MF value (change value) in the MA value (regulation parameter) and is notified to the printer control unit, the flow advances to step ST8.

That is, proof copying in the proof copy mode is executed with the notified “temporary regulation parameter”.

(ST8) is a step of issuing an instruction to start printing (P) to the printer control unit (PR control). When the printer control unit starts proof copying operation with the notified “temporary regulation parameter”, the flow advances to step ST9.

(ST9) is a step of determining whether printing is complete. If printing for proof copying is complete, the flow returns to step ST2. In the embodiment of the present invention, in the proof copy mode, setting can be made to execute proof copying for each piece of image information corresponding to one page or issue a preset number of sheets.

(ST10) is a step of determining whether the proof copy mode is terminated. If the “close” button in the “confirmation window” in FIG. 3 is turned on, the flow advances to step ST11. If this button is not ON, the flow returns to step ST2.

(ST11) is a step of displaying an MA value change confirmation window. An MA value change confirmation window like that shown in FIG. 8 is displayed when the proof copy mode is terminated. The flow then advances to step ST12.

(ST12) is a step of determining whether the MA value is to be changed with respect to all jobs in the image printing mode and the like to be executed subsequently. For example, in the regulation parameter change confirmation window shown in FIG. 8, a popup window is displayed, and the message “Do you replace regulation parameters with changed regulation values?” is displayed.

If the MA value is to be changed, the YES button on the message “Subsequent jobs will be executed with changed regulation value” is pressed. The flow then advances to step ST13. If the MA value is not be changed, the “NO” button on the message “Subsequent jobs will be executed with changed regulation value” is pressed. The flow then advances to step ST15.

(ST13) is a step of performing processing of communicating the “temporary regulation parameter” obtained by reflecting the MF value in the MA value as a “new regulation parameter” to the printer control unit. That is, when “YES” is selected in step ST12, the “new regulation parameter” is communicated to the printer control unit to change the “temporary regulation parameter” into the “new regulation parameter” and use it. The flow then advances to step ST14.

(ST14) is a step of storing the “temporary regulation parameter” obtained by reflecting the MF value in the MA value as the “new regulation parameter”. That is, the input MF value is reflected in the “preset MA value”, and the resultant value replaces the “preset MA value”. That is, according to MA value+MF value=new MA value, the “temporary regulation parameter” is stored as the “new regulation parameter” in the storage section 160, and setting is made to apply the “new regulation parameter” to all subsequent jobs. The flow then advances to step ST16.

Note that as the storage section, which stores regulation parameters, a memory like a nonvolatile RAM is preferably used.

(ST15) is a step of notifying the printer control unit of the “temporary regulation parameter” obtained by reflecting the MF value in the MA value. That is, when “NO” is selected in step ST12, the printer control unit is notified that the “temporary regulation parameter” will be applied to only the job to be executed from now. The flow then advances to step ST16.

(ST16) is a step of starting the execution of the image printing mode. Assume that the proof copy mode is to be terminated and the image printing mode is to be executed. In this case, if “YES” is selected in step ST12, the MA value stored as the “new regulation parameter” is applied to the image printing mode to be executed subsequently. If “NO” is selected, the “temporary regulation parameter” is applied to only the image printing mode as the job to be executed from now. The flow then advances to step ST17.

(ST17) is a step of determining whether printing is complete. If printing is complete, the flow advances to step ST18.

(ST18) is a step of notifying the printer control unit of the MA value. In the embodiment of the present invention, the printer control unit transfers the MA value stored therein to the post-processing device at the same time as the start of issuing operation. The post-processing device then executes predetermined post-processing with the transferred MA value.

In the embodiment of the present invention, therefore, if “YES” is selected in step ST12, the printer control unit is notified of the MA value as the “new regulation parameter” stored in the storage section 160. If “NO” is selected in step ST12, since the MA value stored in the storage section 160 is not changed, the printer control unit is notified of the “preset MA value”.

The printer control unit stores the notified MA value in the storage section of the printer control unit instead of the MA value, which has been previously notified.

As described above, according to the embodiment of the present invention, as examples of procedures in the post-processing device, there have been described an regulation procedure which is executed in the image printing apparatus and post-processing device to change regulation parameters by reflecting input change values (MF values) in preset regulation parameters (MA values), a procedure for changing regulation parameters in the proof copy mode, and the like.

Note that the embodiment of the present invention can be effectively applied to an image printing system, in particular, which serves as an image printing apparatus comprising a post-processing device.

According to the embodiment of the present invention, there can be provided an image printing system, a control method therefor, and a control program in which when change values for changing preset regulation parameters are input to change the issue state of a sheet issued in the proof copy mode into a desired issue state under the post-processing conditions set by the post-processing condition setting section, regulation parameters can be changed on the basis of the input change values, thereby improving operability with simple operation and easily obtaining desired high-quality images and sheets having undergone post-processing.

In addition, there can be provided an image printing system, a control method therefor, and a control program which improve operability or workability in inputting a change value to change a post-processing condition or the like by setting a result obtained by reflecting the change value in an regulation parameter as a new regulation parameter.

In addition, there can be provided an image printing system, a control method therefor, and a control program which improve operability or workability in, for example, setting post-processing conditions or inputting change amounts because post-processing conditions and regulation parameters are associated with each other such that when post-processing conditions are selected/set, change values for changing regulation parameters can be input on the basis of post-processing conditions.

In addition, there can be provided an image printing system, a control method therefor, and a control program which improve operability or workability in, for example, setting the image printing mode or post-processing conditions by providing the display section which can display the image printing mode and post-processing conditions which can be changed after a sheet is issued in the proof copy mode.

Furthermore, there can be provided an image printing system, a control method therefor, and a control program which can check an issue state such as post-processing conditions in the proof copy mode, reduce necessary issuing operation, and easily obtain a desired high-quality image or a sheet having undergone post-processing by allowing the user to select whether changed regulation parameters are set as new regulation parameters, when the image printing mode is to be executed after the end of the proof copy mode.

Moreover, there can be provided an image printing system, a control method therefor, and a control program in which when the user selects to set changed regulation parameters as new regulation parameters, storing the new regulation parameters in the storage section makes it possible to use the new regulation parameters stored in the storage section when the image printing mode is executed subsequently, thereby easily obtaining a desired high-quality image or a sheet having undergone post-processing.

Note that the above description has exemplified the case wherein correction is performed to make post-processing for an image outputted onto a sheet or a sheet fall within the specifications. Obviously, however, the user can obtain a desired issue by intentionally adding change values to regulation parameters by using this regulation function in similar operation procedures.

Note that the image printing apparatus according to the embodiment of the present invention may have a function as a copying machine which reads a document placed on the platen glass or a document fed by the automatic document feeder 30 and copies the document, and a function as a printer which prints an image on a sheet on the basis of image information input from the external information device 500 and issues the sheet. Obviously, in addition, this apparatus may be a multifunctional apparatus having a copying function, printer function, and facsimile function.

What is claimed is:

1. An image printing system comprising:
an image printing apparatus which prints an image on a sheet as a recording medium;
a sheet post-processing section which performs post-processing with respect to the sheet on which an image is printed by said image printing apparatus;
a storage section which stores an regulation parameter for said image printing apparatus, which is associated with setting of the sheet post-processing operation; and
an regulation parameter changing section which can change the regulation parameter for each job to be executed.

2. A system according to 1, wherein said regulation parameter changing section comprises a setting section which can set a change value for the regulation parameter, and can reflect the change value in the regulation parameter to set a new regulation parameter.

3. A system according to claim 1, wherein said sheet post-processing section includes a plurality of kinds of post-processing conditions to be selected, and said regulation parameter changing section can change the regulation parameter on the basis of a selected post-processing condition.

4. A system according to claim 2, wherein said sheet post-processing section includes a plurality of kinds of post-processing conditions to be selected, and said regulation parameter changing section can change the regulation parameter on the basis of a selected post-processing condition.

5. A system according to claim 1, wherein said image printing section can set a proof copy mode for checking the sheet post-processing operation, and said regulation parameter changing section can change the regulation parameter when the proof copy mode is set.

6. A system according to claim 1, further comprising a selection device which can select whether to store a changed regulation parameter as a new regulation parameter in said storage section.

7. A system according to claim 6, wherein when said selection device selects to store a changed regulation parameter as a new regulation parameter, the new regulation parameter is stored in said storage section.

8. An image printing method which prints an image on a sheet as a recording medium and performs predetermined post-processing, comprising the steps of:
setting in advance an regulation parameter for execution of post-processing with respect to the sheet on which an image is printed;
inputting a change value for changing the regulation parameter, for each job to be executed, so as to set post-processing operation suitable for the job; and
changing the regulation parameter on the basis of an input change value.

9. A method according to claim 8, wherein a new regulation parameter is set by reflecting the input change value in the regulation parameter.

10. A method according to claim 8, further comprising the step of selecting a plurality of kinds of post-processing conditions, wherein the regulation parameter is changed on the basis of a selected post-processing condition.

11. A method according to claim 9, further comprising the step of selecting a plurality of kinds of post-processing conditions, wherein the regulation parameter is changed on the basis of a selected post-processing condition.

12. A method according to claim 8, further comprising the step of setting a proof copy mode for checking the sheet post-processing operation, wherein when the proof copy mode is set, the regulation parameter can be changed.

13. A method according to claim 8, wherein whether to store a changed regulation parameter as a new regulation parameter can be selected.

14. A method according to claim 13, wherein if it is selected that a changed regulation parameter is stored as a new regulation parameter, the new regulation parameter is stored.

15. An image printing program for printing an image on a sheet as a recording medium and performing predetermined post-processing, comprising operations of:
setting in advance an regulation parameter for execution of post-processing with respect to the sheet on which an image is printed;
inputting a change value for changing the regulation parameter, for each job to be executed, so as to set post-processing operation suitable for the job; and
changing the regulation parameter on the basis of an input change value.

16. A program according to claim 15, wherein a new regulation parameter is set by reflecting the input change value in the regulation parameter.

17. A program according to claim 15, further comprising an operation of selecting a plurality of kinds of post-processing conditions, wherein the regulation parameter is changed on the basis of a selected post-processing condition.

18. A program according to claim 16, further comprising an operation of selecting a plurality of kinds of post-processing conditions, wherein the regulation parameter is changed on the basis of a selected post-processing condition.

19. A program according to claim 15, further comprising an operation of setting a proof copy mode for checking the sheet post-processing operation, wherein when the proof copy mode is set, the regulation parameter can be changed.

20. A program according to claim 15, wherein whether to store a changed regulation parameter as a new regulation parameter can be selected.

21. A program according to claim 20, wherein if it is selected that a changed regulation parameter is stored as a new regulation parameter, the new regulation parameter is stored.
